(19) United States
(12) Patent Application Publication
(10) Pub. No.: US 2026/0320656 A1
(43) Pub. Date: Oct. 15, 2026

(54) ACTIONABLE INSIGHTS IN A RETAIL ENVIRONMENT

(71) Applicant: Albertsons Companies, Inc., Boise, ID (US)

(72) Inventors: Rahul N. Shah, Frisco, TX (US); Senthilkumar Kathiresan, Milpitas, CA (US); Mitulkumar Limbasiya, San Ramon, CA (US)

(21) Appl. No.: 19/638,529

(22) Filed: Apr. 3, 2026

Related U.S. Application Data
(60) Provisional application No. 63/788,384, filed on Apr. 14, 2025.

(51) Int. Cl. G06Q 30/0282; G06N 3/0475

(52) U.S. Cl. CPC G06Q 30/0282; G06N 3/0475

(57) ABSTRACT

Disclosed herein are techniques for determining actionable insights in a retail environment based on processing disparate data types. A system can perform operations that can include: ingesting data associated with a retail environment, the data including customer feedback of disparate data types, processing the ingested data to determine customer sentiment associated with the customer feedback of disparate data types, determining, based on the customer sentiment, actionable insights for the retail environment, generating output based at least in part on the actionable insights, and returning the output for presentation in a graphical user interface (GUI) display of a user device.

### PRIORITY CLAIM

This application claims the benefit of and priority to U.S. Provisional Patent Application No. 63/788,384, filed on Apr. 14, 2025. The disclosure of the above-referenced application is incorporated herein by reference in its entirety.

### TECHNICAL FIELD

This disclosure generally describes devices, systems, and methods related to artificial intelligence (AI) powered techniques that analyze data from disparate data sources and/or disparate data types, such as customer feedback, and generate actionable insights in a retail environment.

### BACKGROUND

Retail businesses operate in a dynamic and competitive environment where customer satisfaction is paramount. Understanding customer needs and preferences is crucial for success, yet existing systems for gathering customer feedback, such as surveys and focus groups, provide limited and delayed insights.

Retail environments, such as stores, can collect shopper feedback from a variety of sources but may manually sort through the data in a time-consuming process. This can result in delays and inaccuracies in understanding customer needs, thereby causing annual loss in revenue per store due to missed opportunities.

### SUMMARY

The disclosure generally describes technology for AI-powered techniques configured to analyze customer feedback from different, disparate data sources and/or types (e.g., mobile application reviews, online reviews, in-store reviews, social media, product reviews, phone calls, customer service contacts). The disclosed technology can leverage advanced natural language processing (NLP) techniques that are trained and deployed in AI environments. The AI-powered techniques can further be used to generate actionable insights for retail environments based on processing the customer feedback and other data from the many sources. For example, the disclosed technology can provide store directors or other relevant users with real-time insights regarding customer sentiment, identification of key issues in the retail environment, and predictions of potential churn. The real-time insights can include daily snapshots of shopper experience trends, both positive and negative, for use in making timely, actionable steps for improvement. The disclosed technology can also provide the relevant users with actionable insights for addressing the customer sentiment, issues in the retail environment, and/or potential churn. Such a data-driven approach empowers the relevant users to improve customer satisfaction, optimize operations, and drive business growth.

As an illustrative example, the disclosed AI-powered system can analyze customer feedback from various sources, such as in-store conversations, online reviews, social media mentions, and customer service inquiries. Based on the analysis, the disclosed technology can extract information such as customer sentiment (positive, negative, neutral), identify recurring themes, and pain points, and predict potential customer churn. This data and outputs can then be presented to relevant users in a user-friendly and easily digestible format, such as dashboards, reports, and personalized alerts presented in graphical user interface (GUI) displays. Moreover, the disclosed technology can include an AI-powered chatbot, which can summarize different aggregated data sources for a store and provide actionable insights in real-time to a user interacting with the chatbot. The AI techniques described herein can aggregate the data sources with quick summarization techniques without requiring users to write complex queries to perform such actions.

One or more embodiments described herein can include a system for determining actionable insights in a retail environment based on processing disparate data types, the system including processors and memory storing instructions that, when executed by the processors, cause the processors to perform operations that may include: ingesting data associated with a retail environment, the data including customer feedback of disparate data types, processing the ingested data to determine customer sentiment associated with the customer feedback of disparate data types, determining, based on the customer sentiment, actionable insights for the retail environment, generating output based at least in part on the actionable insights, and returning the output for presentation in a graphical user interface (GUI) display of a user device.

In some implementations, the embodiments described herein can optionally include one or more of the following features. For example, the operations may also include: receiving, from the user device, user input in a chatbot presented at the user device, the user input indicating a request for information about the retail environment, identifying the data associated with the retail environment based on processing the user input, and performing the ingesting, the processing, the determining, the generating, and the returning based on identifying the data associated with the retail environment. The operations may also include: generating, using AI, a summarization of at least one of the customer sentiment and the actionable insights for the retail environment, and returning the summarization for presentation in the GUI display of the user device.

In some implementations, the ingested data can include business coding combinations, and processing the ingested data to determine the customer sentiment associated with the customer feedback of disparate data types further can include: categorizing the customer feedback of disparate data types based on applying an AI model to the ingested data. The AI model could have been trained to correlate the customer feedback of disparate data types with at least one of the business coding combinations to categorize the customer feedback of disparate data types. Sometimes, determining the customer sentiment further can include applying the AI model to the categorized customer feedback of disparate data types. The AI model could have been trained to determine the customer sentiment based on semantically analyzing the categorized customer feedback of disparate data types.

The AI model could have been trained in a process that may include: retrieving a pre-trained model, retrieving training data, categorizing the training data based on one or more business rules, refining the categorized training data based on performing an ambiguity and hallucination analysis, determining sentiments associated with the categorized training data, and fine-tuning the pre-trained model based on the refined training data and the determined sentiments to generate the AI model. Sometimes, the pre-trained model can include a large language model (LLM). The training data can include business-specific data, retail-specific data, customer feedback over one or more periods of time, and domain-specific language data. Categorizing the training data based on the one or more business rules can include: classifying the customer feedback, and applying coding combinations of the one or more business rules to the classified customer feedback of disparate data types to generate the categorized training data.

In some implementations, processing the ingested data to determine the customer sentiment associated with the customer feedback of disparate data types can include: processing the customer feedback of disparate data types to identify phrases in the customer feedback of disparate data types, determining intents for the identified phrases, applying three-tier coding to the intents, determining sentiments for the intents, determining a confidence score based on the intents, the three-tier coding, and the sentiments, and determining the customer sentiment based on a combination of the intents, the three-tier coding, the sentiments, and the confidence score. Determining, based on the customer sentiment, the actionable insights for the retail environment can include identifying issues to address in the retail environment to improve the customer sentiment. Determining, based on the customer sentiment, the actionable insights for the retail environment can include identifying areas of improvement in the retail environment to improve the customer sentiment. Determining, based on the customer sentiment, the actionable insights for the retail environment can include generating recommendations for improving employee training in the retail environment. Determining, based on the customer sentiment, the actionable insights for the retail environment can include generating recommendations to improve resource allocation and strategy in the retail environment.

Generating the output based at least in part on the actionable insights can sometimes include generating visualizations of the actionable insights and a summarization of the customer feedback of disparate data types in a dashboard for presentation in the GUI display of the user device. Generating the output based at least in part on the actionable insights can include generating reports of the actionable insights and a summarization of the customer feedback of disparate data types. Generating the output based at least in part on the actionable insights can include generating emails reporting the actionable insights and a summarization of the customer feedback of disparate data types. Generating the output based at least in part on the actionable insights can include generating personalized alerts about the actionable insights and a summarization of the customer feedback of disparate data types. Sometimes, the output can be presented in a dashboard in the GUI display of the user device. The actionable insights can be presented in a chatbot that can be presented simultaneously with the dashboard in the GUI display of the user device. The dashboard can present, as graphical elements, other information about the retail environment and the customer sentiment. The output can be presented in a chatbot in the GUI display of the user device. The customer feedback of disparate data types can include at least one from a group consisting of: customer reviews, video chats, audio conversations, product reviews, social media reviews, video reviews, and audio reviews. The data can be ingested from one or more external data systems. The data can be ingested from one or more mobile applications. The data can be ingested from one or more customer service systems. The ingested data can include business rules and retail environment information.

The devices, system, and techniques described herein may provide one or more of the following advantages. For example, the disclosed technology can automate data processing and provide real-time insights in the context of shopper experiences in retail environments. Compared to existing systems, which typically require human review, analysis, and input, the disclosed technology can reduce processing time by approximately 95% to analyze data from many different sources and generate accurate, reliable actionable insights on various different levels (e.g., divisional level, district level, store level). The disclosed technology overcomes technical challenges in obtaining and processing data from different data sources, including structured and unstructured data, analyzing said data, and refining the analyses in such a way that provides actionable insights and summaries for a relevant user, such as a store director. The disclosed technology provides technical solutions over the existing systems by providing a streamlined, AI-powered data ingestion and processing pipeline that is designed to accurately process the disparate types of data to generate the actionable insights in seconds to mere minutes. For example, a generative AI (GenAI) assistant/chatbot can be implemented with the disclosed techniques to simplify data analysis processes and deliver actionable insights in less than 2 minutes. The AI-techniques can also be trained to access and summarize data from many different sources, without requiring human input such as complex queries and other human-generated prompts. The existing systems, on the other hand, rely on simplistic sentiment analysis and lack sophistication to extract nuanced and actionable insights from diverse data sources. This limitation hinders the ability of relevant users to proactively address customer concerns, optimize store operations, and make data-driven decisions that enhance the customer experience. Furthermore, the lack of real-time insights and difficulty in translating raw data into actionable recommendations with the existing systems leads to missed opportunities and inefficient resource allocation. The existing systems require users to possess data analysis skills and write complex queries to access and interpret data. The disclosed technology, on the other hand and as described herein, provides technical solutions to the existing systems that lack the technical prowess to process mass amounts of data and generate accurate, actionable insights accordingly.

Not only does the disclosed technology provide technical solutions to existing systems that lack advanced data ingestion and processing pipelines, the disclosed technology also provides for generating the actionable insights in such a way that is not possible in the human mind. The AI-powered system and techniques can process thousands to millions of disparate types of data points within seconds in order to glean particular, nuanced, and sometimes hidden aspects in customer feedback (e.g., sentiment, key trends), which can then be further processed (in parallel or in series) to determine actionable insights to improve the customer experiences and improve the overall opportunities and operations at the retail environment. None of this can be reasonably performed in the human mind.

Similarly, the disclosed technology provides for complex and uniquely trained models that reduce processing time and improve consumption of available resources to generate the actionable insights described herein. Such training cannot be reasonably performed in the human mind, including but not limited to specific operations that the model can be trained to perform, the iterative and real-time execution of the disclosed models to generate reliable and accurate results, and the receipt and processing of disparate types of data all in real-time or near real-time. The disclosed technology provides efficient model training that does not require human intervention or input, which makes it impossible for this technology to be reasonably performed in the human mind. The model(s) can be iteratively executed during runtime and simultaneously updated to generate reliable and accurate outputs, functions that also cannot be reasonably performed in the human mind.

After the disclosed technology generates actionable insights, the disclosed technology can display relevant information and data using a GUI on a display of user/computing devices of the relevant users in a unique and easy way to understand format. The existing systems may not provide the disclosed solutions for at least the following reasons: (i) the significant processing power required for to process such vast amounts of information and generate actionable insights specific to a particular retail environment on one or more granular levels, (ii) the considerable data storage requirements for maintaining information collected and determined by the disclosed technology, (iii) algorithms, AI, and/or other machine learning techniques that allow for the automated generation and regeneration of actionable insights based on additional data that can be retrieved during runtime, and/or (iv) other hardware and software features described herein.

In addition, the GUI displays results of the execution of these complex algorithms, AI, and/or machine learning techniques in a manner that can be easily understandable by a human user. The information can be processed for presentation on small or handheld screens, which can improve operation of computing devices, etc. Additionally, translation of outcomes from these complex algorithms, AI, and/or machine learning techniques through the GUI onto images or other information displayed for a user can improve comprehension of considerable quantities of highly processed data. For example, an exemplary algorithm from this complex collection of algorithms can require: receiving data from many different sources, cleansing the data, selecting some data, ignoring some of the data, performing multiple processes on a selected subset of the data, combining the data from these multiple process, and then outputting that data within a short amount of time (e.g., less than a minute), all for multiple relevant users to view in GUIs. The use of AI techniques described herein can therefore improve the functioning of the user devices to improve their consumption and use of resources in presenting relevant information to the user in a user-friendly manner.

The disclosed technology can also provide improved shopping and customer experiences, enhanced brand loyalty, reduced customer churn, data-driven decision making, improved operational efficiency, enhanced employee training, improved employee performance, real-time actionable insights to improve the above, and/or integrate comprehensive analysis into the fabric of the retail environment. As a result, the disclosed technology can provide for enhanced efficiencies on many levels of the retail environment and guide for improved strategic initiatives to more directly and accurately address revenue loss or other issues in the retail environment. In some implementations, the disclosed technology can also provide competitive advantages to the retail environments, by generating insights about customer needs and preferences to enable proactive responses and a superior customer experience to competitors. In other words, the disclosed technology can be used to identify and resolve issues before they escalate, leading to increased customer satisfaction. The disclosed technology can be used to identify areas for improvement in customer service, product offerings, and/or in-store experiences. Similarly, the disclosed technology can equip employees with knowledge and skills needed to better understand and address customer needs. Real-time customer insights can further be used to make informed decisions about store strategy and resource allocation. By providing a continuous stream of valuable customer intelligence, the disclosed technology can improve retail businesses, build stronger customer relations, improve operational efficiency, and drive revenue growth.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a conceptual diagram of a system for generating actionable insights about a retail environment based on customer feedback.

FIG. 2 is a diagram of another system for generating actionable insights using the disclosed techniques.

FIGS. 3A and 3B are a flowchart of a process for analyzing customer feedback to generate actionable insights.

FIG. 4 is a flowchart of a process for generating curated output based on user interactions with a chatbot.

FIGS. 5A and 5B are a flowchart of a process for training a model to generate summarizations and actionable insights based on user prompts in a chatbot.

FIGS. 6A, 6B, 6C, and 6D illustrate example graphical user interfaces (GUIs) that can be presented at a user device.

FIG. 7 is a flowchart of a process for determining intents from customer feedback and generating associated results, such as actionable insights.

FIG. 8 is a diagram of a dataflow to generate actionable insights described herein.

FIG. 9 is an illustrative example of using the disclosed techniques of FIG. 7 to determine intents from customer feedback.

FIG. 10 is an example system architecture that can be used to perform the disclosed techniques.

FIG. 11 is a schematic diagram that shows an example of a computing device and a mobile computing device.

In the present disclosure, like-numbered components of various embodiments generally have similar features when those components are of a similar nature and/or serve a similar purpose, unless otherwise noted or otherwise understood by a person skilled in the art.

### DETAILED DESCRIPTION OF ILLUSTRATIVE EMBODIMENTS

This disclosure generally relates to techniques for processing data associated with customer feedback to generate actionable insights for improving operations in a retail environment.

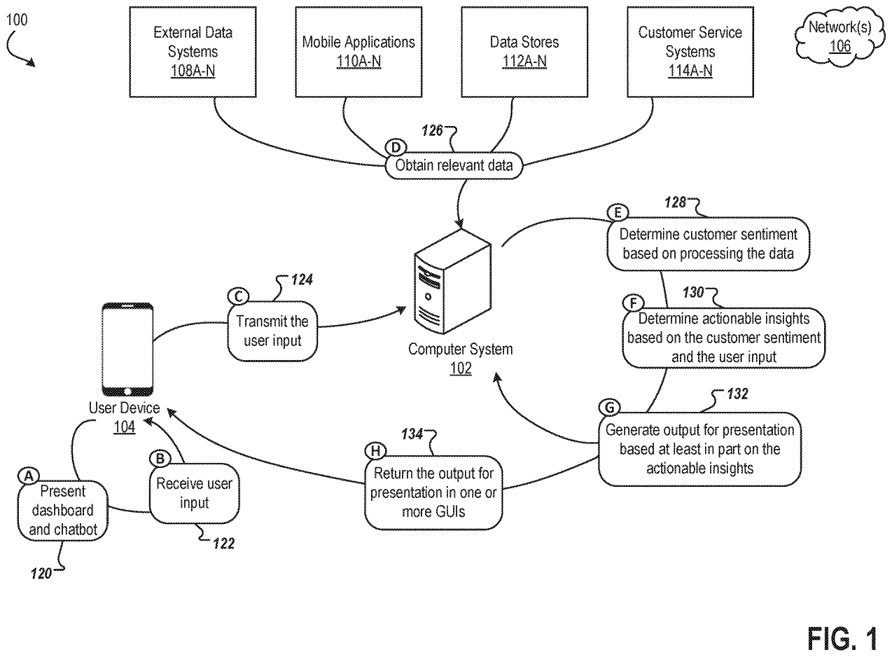

Referring to the figures, FIG. 1 is a conceptual diagram of a system 100 for generating actionable insights about a retail environment based on customer feedback. The system 100 can include a computer system 102 in communication (e.g., wired, wireless) via network(s) 106 with a user device 104. The computer system 102 can be configured to implement one or more AI-powered pipelines, algorithms, models, and/or other operations to generate actionable insights by processing mass amounts of data from disparate data sources and/or data types. The computer system 102 can be in the cloud or remote from any particular retail environment. In some implementations, the computer system 102 can be part of or within a particular retail environment. The user device 104 can be used by relevant users of the retail environment. The user device 104 can include a mobile device, smartphone, mobile phone, laptop, tablet, and/or computer.

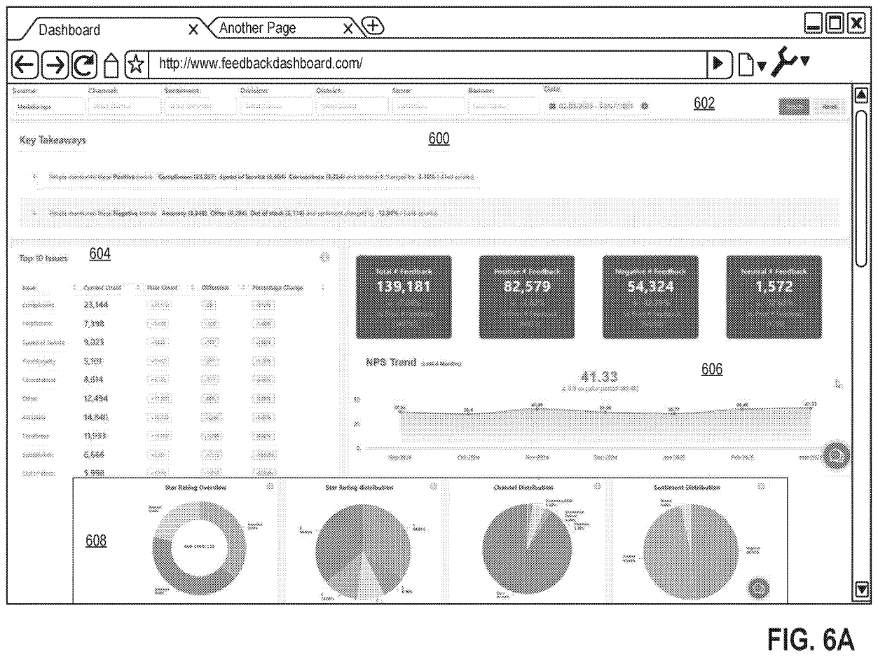

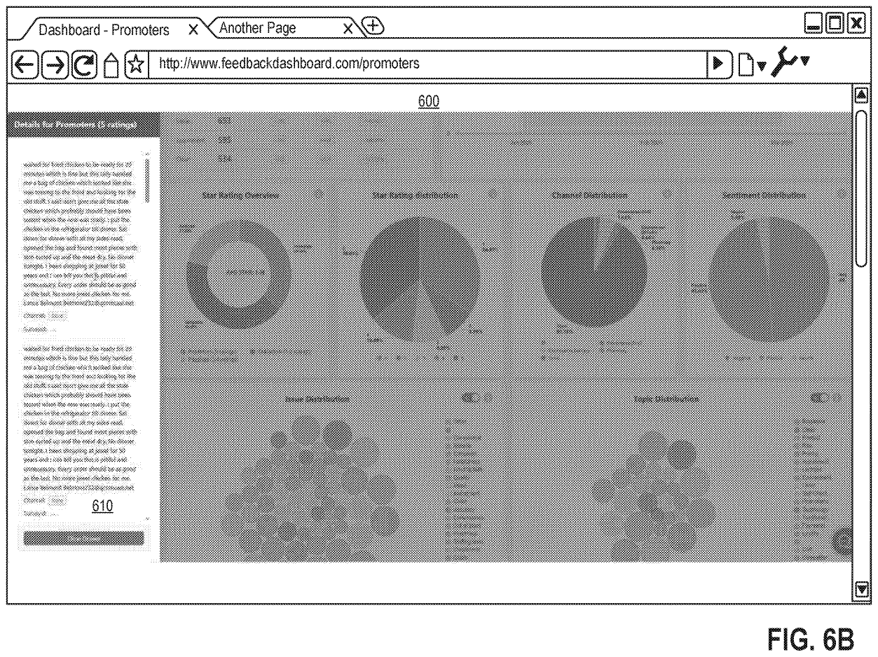

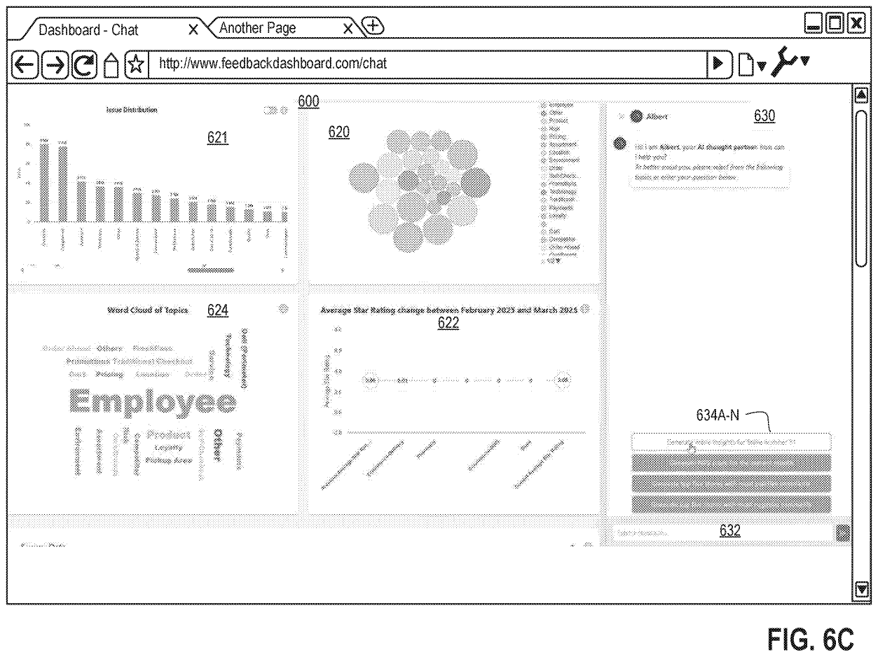

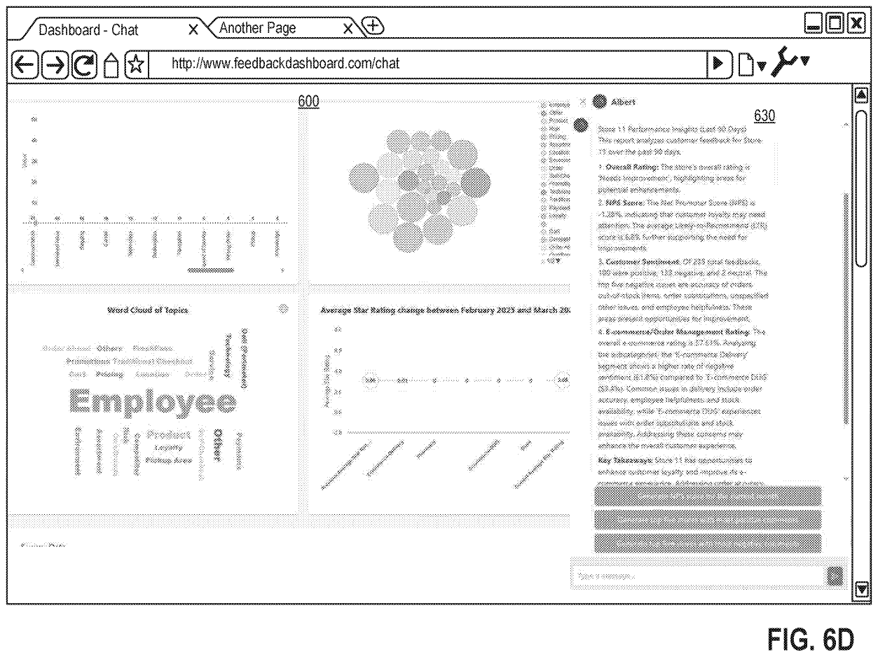

In the system 100, a dashboard and/or chatbot can be presented at the user device 104 in block A (120). Refer to FIGS. 6A, 6B, 6C, and 6D for further discussion. The dashboard can present metrics or other information about a particular retail environment and/or district. The dashboard can present information such as actionable insights, which can be implemented in the particular retail environment or the district to improve operations. The chatbot can provide an interface for the user to interact with the computer system 102 and provide inputs for the computer system 102 to perform the disclosed techniques.

The user device 104 can receive user input in response to the presenting (block B, 122). For example, a relevant user can input a question, query, or other prompt into the chatbot. The user can ask about customer sentiment for a particular store, district, department, product, and/or category of products. The user can ask for recommendations or other actionable insights to improve a particular aspect of the business/retail environment, as another example. The user can provide one or more other illustrative prompts, including but not limited to prompts for (i) generating an NPS score for a previous month or other period of time, (ii) providing detailed insights for a particular store number/identifier or a group of stores, (iii) listing top 5 stores or any other listing of top stores with positive comments over a predetermined period of time, (iv) listing top 5 stores or any other listing of top stores with negative comments over a predetermined period of time, (v) generating additional insights for one or more different divisions of retail stores.

The user device 104 can transmit the user input to the computer system 102 in block C (124).

The computer system 102 can also receive or otherwise obtain relevant data from one or more sources, including but not limited to external data systems 108A-N, mobile applications 110A-N, data stores 112A-N, and/or customer service systems 114A-N (block D, 126). The data can include customer feedback in various different formats and/or types. For example, the data can include text data, image data, voice data, and/or chat data. The data can also be obtained for one or more periods of time, such as a last day, a current day, a last month, a last 3 months, a last 6 months, a last year, etc. The computer system 102 can process the user input to identify a particular retail environment, district, product, and/or category of products that the input pertains to. The computer system 102 can perform advanced NLP, textual analysis, and/or semantic analysis techniques to identify what the input pertains to. Based on the identification, the computer system 102 can poll one or more data sources for the relevant data. Any of the data obtained in block D (126) can include NPS scores, NPS surveys, product reviews, customer complaints, customer reviews, product reviews, social media location-based reviews, user experiences in a mobile application, etc.

The external data systems 108A-N and the data stores 112A-N can include but are not limited to data repositories, data stores, data lakes, and/or other computing systems and/or computing networks that may be configured to generate and/or maintain information about retail environments, districts, products, categories of products, etc. An example external data system 108A-N can include a net promoter score (NPS) system, which generates NPS surveys in which a customer can score the retail environment to show the customer's loyalty and/or satisfaction with the retail environment and/or business as a whole. The mobile applications 110A-N can include applications that are launched at computing devices of customers and other end users, and used during and/or for shopping experiences. The mobile applications 110A-N can include prompts, notifications, and/or surveys requesting feedback from the customers regarding their shopping experience. The customer service systems 114A-N can be configured to communicate with customers about their shopping experiences and help the customers resolve potential issues that arise from said experiences. The customer service systems 114A-N can include telephone/voice systems and/or email or other written communication systems.

The computer system 102 can determine customer sentiment based on processing the relevant data that was obtained (block E, 128). Determining the customer sentiment can include processing the data to glean relevant information. The vast amount of data that is obtained and subsequently processed cannot be reasonably processed or analyzed in the human mind. In addition to processing and cleaning the many different data points that are obtained in block D (126), the computer system 102 can also understand the sentiment in the feedback. The computer system 102 can apply one or more AI, other modeling techniques, semantic analysis, NLP, and/or textual analysis described herein to glean the customer sentiment from the obtained data. The customer sentiment can include string, Boolean, and/or integer values that correspond to one or more different categories of sentiment (e.g., positive, neutral, negative, good, neutral, bad).

In block F (130), the computer system 102 can determine actionable insights based on the customer sentiment and the user input. The computer system 102 can perform additional processing techniques described herein with AI and/or other models in order to identify how the retail environment can improve operations in order to improve the customer sentiment, and subsequently, customer feedback. The actionable insights can include, but are not limited to, recommendations for restocking out of stock products, restocking products that have low stock in the retail environment, employee training, offering sales or other promotions to the customers, improving customer service offers and/or interactions with the customers, etc.

The computer system 102 can also generate output for presentation based at least in part on the actionable insights in block G (132). Generating the output can also include using AI techniques described herein to generate a summary of the user input (e.g., the user's query), the determined customer sentiment, the determined actionable insights, and/or any combination thereof. Refer to FIGS. 6A, 6B, 6C, and 6D for further discussion about the output.

Accordingly, the computer system 102 can return the output for presentation in one or more GUIs at the user device 104 (block H, 134). Sometimes, the user device 104 can receive user feedback in response to the presentation, which can be transmitted to the computer system 102 and used for iteratively training the AI and modeling techniques described herein and/or for improving/refining determinations that are made by the computer system 102.

In some implementations, blocks D-H (126-134) can be performed without first performing blocks A-C (120-124).

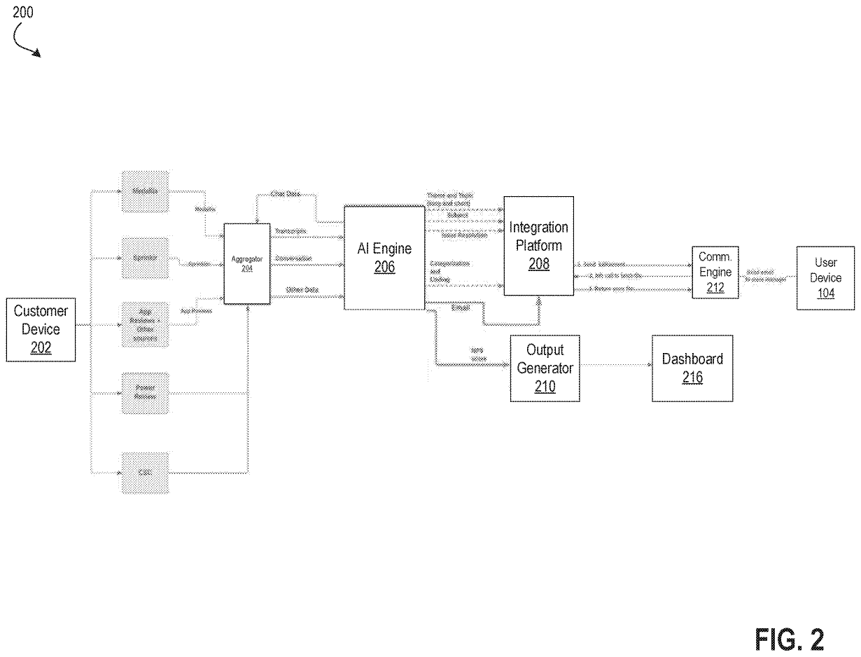

FIG. 2 is a diagram of another system 200 for generating actionable insights using the disclosed techniques. The system 200 can include components of the system 100 described in reference to FIG. 1. In some implementations, components of the system 200 can be part of the computer system 102, which can be configured to generate the actionable insights.

Referring to the system 200, customer feedback can be provided as input at a customer device 202 (e.g., computing device as described in reference to FIG. 1). The customer feedback can be provided through one or more modes, mechanisms, and/or channels. Illustrative examples of said channels can include but are not limited to MEDALLIA, SPRINKLR, other application reviews and other similar sources, POWER review, and/or CSC. MEDALLIA is a platform that can be used to conduct surveys with customers about their shopping and/or store experiences. SPRINKLR can be used to collect social media reviews about brands and/or banners from various different websites or other social media platforms. POWER review can be used to gather product reviews through emails sent by customers. CSC, or customer service center, can be any type of customer service platform that allows customers to provide feedback via voice, chat, and/or email communication channels.

The customer feedback from the customer device 202 can be ingested by an aggregator 204. The aggregator 204 can be part of the computer system 102. In some implementations, the aggregator 204 can include one or more input tables and/or other structures for maintaining the received data. The data can also be aggregated and sometimes cleaned/processed at the aggregator 204.

An AI engine 206 (which may be part of the computer system 102, in some implementations) can include a data pipeline for ingesting data from the aggregator 204. The AI engine 206 can ingest any quantity of data from the aggregator 204, including but not limited to chat data, transcripts and/or conversations from phone calls or other customer service inquiries, and/or other data described herein. In some implementations, the AI engine 206 can obtain chat data from the user device 104 via the communication engine 212 and an integration platform 208. The AI engine 206 can then process the chat data to identify what particular aspects of a retail environment and/or district a user at the user device 104 is asking about. The AI engine 206 can then retrieve data that is relevant to this identification. Once the AI engine 206 ingests the relevant data, the engine 206 can be configured to perform the disclosed techniques to combine and analyze the data to generate the actionable insights for the user at the user device 104.

As mentioned above, the AI engine 206 can communicate with the integration platform 208 and/or the output generator 210. The integration platform 208 can be configured to provide services for communicating with the user device 104. For example, the integration platform 208 can be configured to generate emails to the user device 104. The integration platform 208 can include an internet or other communication service for managing the emails. Thus, the integration platform 208 can send emails to the user device 104 through this microservice architecture based on output generated by the AI engine 206. The integration platform 208 may also include one or more security layers to ensure that third party integration goes through the integration platform 208 of the system 200. The integration platform 208 can be part of the computer system 102.

The output generator 210 can be configured to generate GUIs in a dashboard 216 for presentation at the user device 104. Refer to FIGS. 6A, 6B, 6C, and 6D for further discussion about the GUIs.

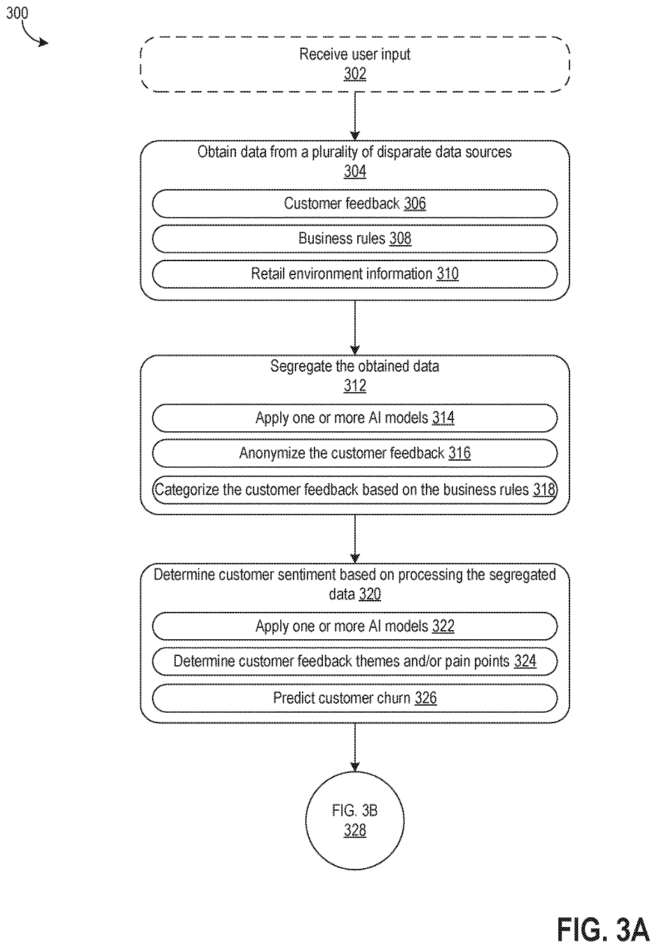

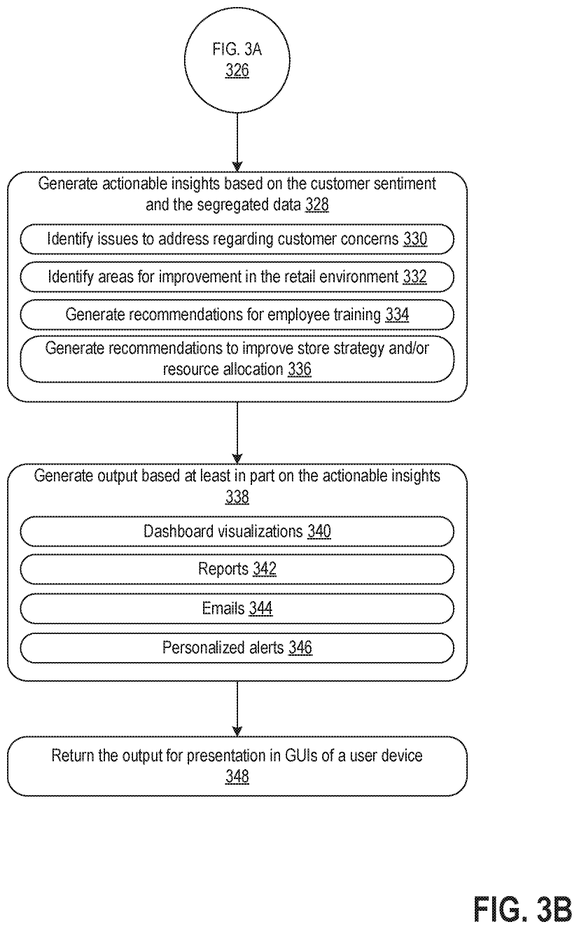

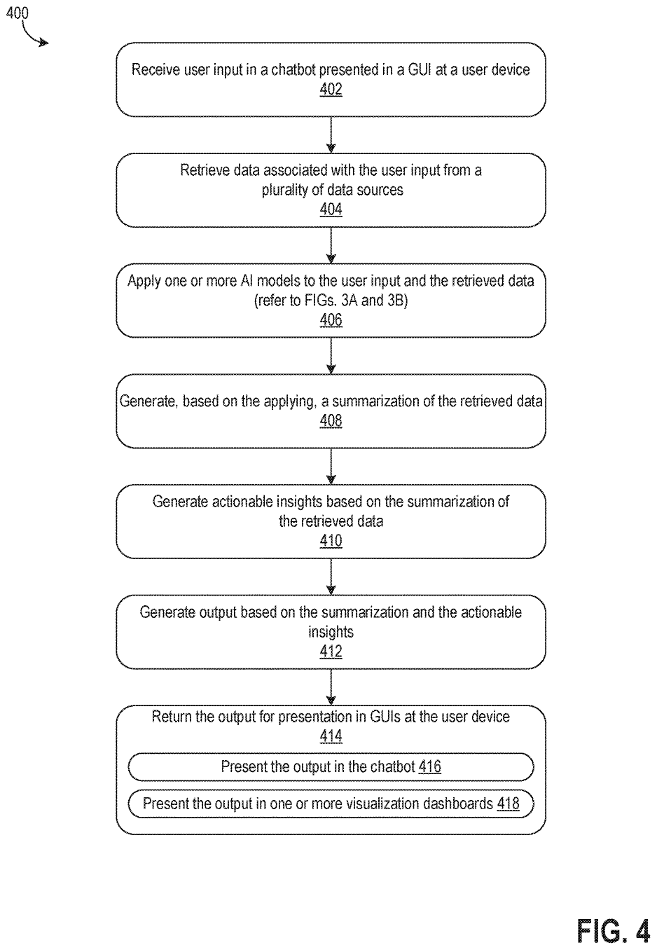

FIGS. 3A and 3B are a flowchart of a process 300 for analyzing customer feedback to generate actionable insights. The process 300 can be performed by components of the computer system 102 that are described in reference to at least FIGS. 1 and 2. The process 300 can also be performed by one or more other software modules, applications, and/or engines that are programmed to perform the disclosed techniques. Such software modules, applications, and/or engines can be implemented by one or more computing systems, devices, computers, networks, cloud-based systems, and/or cloud-based services. For illustrative purposes, the process 300 is described from the perspective of a computer system.

Referring to the process 300 in both FIGS. 3A and 3B, the computer system can optionally receive user input in block 302. The user input can indicate a desire of a relevant user to know what is happening with a particular retail environment, district, and/or product in terms of customer satisfaction/experiences. The user input can include a query, prompt, or question inputted into a chatbot in a dashboard presented at the user's device. Refer to FIG. 4 for further discussion. The user input can include selection of one or more selectable options or buttons in the dashboard. In some implementations, the user input can include text data, audio data, and/or visual data. Refer to FIGS. 6A, 6B, 6C, and 6D for further discussion. Sometimes, the process 300 can start without first receiving the user input. In other words, the process 300 can start with block 304 at predetermined time intervals (e.g., once a day, once every 12 hours, once every 1 hour, once every 2-3 days).

In block 304, the computer system can obtain data from a plurality of disparate data sources and/or data types. The data can include customer feedback (block 306), business rules (block 308), retail environment information (block 310), and/or any combination thereof. Refer to at least FIGS. 1 and 2 for further discussion about the customer feedback in block 306. The business rules in block 308 can be maintained in a data store and can be associated with a particular retail environment, product(s), and/or district. The business rules can define how products are categorized and/or how feedback can be associated with the products. The business rules can be used to link feedback intents with relevant business and/or product lines. These business rules can provide guidelines to help identify intents and apply appropriate categorization to feedback entities. For example, queries related to discounts and/or rewards can be mapped to a loyalty category while queries about product price ranges and related comparisons can be mapped to a competitor category.

The computer system can determine which business rules to retrieve based on processing the user input as described herein to glean insight into what the user is asking about/looking for in returned output. The retail environment information (block 310) can include data relating to the particular retail environment, product(s), and/or district over one or more periods of present and/or past time periods. The computer system can gather various types of information, including but not limited to online order details, store information, discounts, coupons, refund history, rewards history, competitor pricing, delivery service details, shopping history, product qualities, and/or other relevant customer data. This comprehensive data collection can be used by the computer system to provide accurate and insightful recommendations as described herein.

The computer system can segregate the obtained data in block 312. The data can be segregated on one or more different levels, including but not limited to a retail store level, regional level, district level, service level, etc. For example, the computer system can apply one or more AI models to segregate the data, where the AI is trained based on the disclosed techniques (block 314). The computer system can employ various business rules and algorithms to effectively segregate and categorize the data. For example, should a customer express a complaint regarding mobile application performance and/or functionality, the computer system can assign the complaint to a technology/functionality category. This segregation process can entail analyzing and comprehending context of the complaint using the business rules and applying a most appropriate coding combination. Furthermore, the computer system can incorporate a cleaning process that automatically eliminates redundant comments from the data and filters out those that do not conform to established business guidelines. As a merely illustrative example, intents and/or comments containing abusive language or irrelevant to the business can be excluded from further processing.

The computer system can anonymize the customer feedback as part of the segregating (block 316). Anonymizing the data can include identifying secure and/or private data and removing it. As a result, the secure/private data may not be used in the rest of the process 300. The computer system can categorize the customer feedback based on the business rules (block 318). Categorizing the feedback can further be based on coding combinations of the business rules. The AI techniques can be trained to apply the business rules to the data. The computer system can apply the business rules and coding combinations to classify customer feedback into one or more of the following categories: theme, channel, issue description, topic, sentiment, and/or any combination thereof. For example, if a customer's comment pertains to product availability, illustrative output can be generated by the computer system as the following: the feedback can indicate that the product was listed as in stock but was not available and the identified topics can include product, issue: out of stock; sentiment: negative; theme/channel: ecommerce.

As an illustrative example, the computer system can segregate the data into distinct and separate phrases, then process each phrase to identify what aspect of customer feedback the phrase corresponds to. Customer feedback indicating that a product is good but there was delay in the delivery service can be segregated into a phrase about the product being good and a phrase about the delivery delay. The computer system can then categorize each phrase based on the aspect of customer feedback that the phrase corresponds to. Such categories can include but are not limited to product quality, service during an in-store purchase, service during a delivery, etc. In the above example, the phrase about the product being good can be categorized as product quality and the phrase about the delivery delay can be categorized as service during a delivery. The computer system can train and deploy one or more machine learning models and/or AI techniques to perform this disclosed process.

Accordingly, the computer system can determine customer sentiment based on processing the segregated data (block 320). The customer sentiment can include strings, integers, and/or Boolean values representing positive, negative, and/or neutral sentiments. The computer system can apply one or more AI models in block 322 that are trained with the disclosed techniques. The AI models can include GenAI techniques. The AI can be trained on tones/customer sentiment that are known or otherwise annotated in the retail environment and industry on a whole. For example, tone verbiage from past or historic customer feedback can be segregated, processes, labeled/annotated with tones, mapped to known customer sentiments, then used to train the AI to accurately determine the customer sentiment herein. NLP, semantic analysis, and/or text analysis techniques can also be applied by the computer system and/or learned by the AI model(s) to identify a tone of a customer in each of the categorized phrases of customer feedback. The tone can be gleaned from audio, text, and/or visual customer feedback data (e.g., customer feedback of disparate data types). Accordingly, the computer system can determine customer feedback themes and/or pain points (block 324). The computer system can be trained using diverse feedback and business rules. The system can leverage survey data and various inputs from survey forms to automatically identify overarching themes, which can serve as high-level categorizations. Once a theme is identified, the computer system can analyze pain points within the comments or other feedback and automatically assign relevant topics and issues. As an illustrative example, the customer feedback can include: “Rotten produce, I was given yogurt and syrup that were past their expiration date.” The computer system can process this feedback using the disclosed techniques to assign an appropriate theme, pain points, and/or sentiment. The computer system can determine a theme of pickup, a topic of product, an issue of freshness, and a sentiment of negative.

The computer system can predict customer churn (block 326). Predicting customer churn can include analyzing various data points to identify patterns that indicate a customer might leave or otherwise is associated with negative sentiments. Historical data on customer interactions, usage patterns, surveys sentiments, etc. can also be analyzed by the computer system to make predictions of likelihood that the customer will leave and go to another retail store or business.

In block 328, the computer system can generate actionable insights based on the customer sentiment and the segregated data. Such insights can be generated using the disclosed models and/or AI. For example, the computer system can identify issues to address regarding customer concerns (block 330). The computer system can identify areas for improvement in the retail environment (block 332). The computer system can generate recommendations for employee training (block 334). The computer system can generate recommendations to improve store strategy and/or resource allocation (block 336). One or more other actionable insights may additionally or alternatively be generated by the computer system. Said other actionable insights can be related to but are not limited to whether the particular retail store is doing well according to threshold expectations, whether a particular department is not meeting threshold expectations, whether one or more employees and/or team members are performing at or above threshold expectations (and should be awarded for doing so), whether inaccurate products are being delivered to customers, whether products are being delivered on time, etc.

For example, the computer system can analyze data from a last n days based on specific configurations to generate recommendations and actions. The computer system can return daily and/or weekly emails containing reports on negative feedback. The computer system may generate a tracker and integrate it into a tracking system for purposes of monitoring the customer feedback or data during the last n days. For example, if a store in a certain division or district receives numerous comments about item availability, the computer system can generate and return insights and recommendations to address this out-of-stock issue. Furthermore, if customers mention a specific product name and identify it as a significant concern for that store, the computer system can finetune their recommendations and provide detailed updates at the product level for relevant users at the particular store.

The computer system can then generate output based at least in part on the actionable insights (block 338). The output can include dashboard visualizations (block 340), reports (block 342), emails (block 344), and/or personalized alerts (block 346). The personalized alerts can be generated to enable relevant users to configure alerts at the store, district, and/or division levels. Users can set up alerts for NPS or other issues of interest. For example, a user can configure an alert to notify them if the NPS for a particular store drops by more than a specified or threshold percentage. The computer system can then generate appropriate alerts and return them to a device of the user (e.g., in an email, in one or more UIs). Refer to at least FIGS. 6A, 6B, 6C, and 6D.

The computer system can accordingly return the output for presentation in GUIs of a suer device in block 348. Refer to at least FIGS. 6A, 6B, 6C, and 6D.

FIG. 4 is a flowchart of a process 400 for generating curated output based on user interactions with a chatbot. The process 400 can be performed by components of the computer system 102 that are described in reference to at least FIGS. 1 and 2. The process 400 can also be performed by one or more other software modules, applications, and/or engines that are programmed to perform the disclosed techniques. Such software modules, applications, and/or engines can be implemented by one or more computing systems, devices, computers, networks, cloud-based systems, and/or cloud-based services. For illustrative purposes, the process 400 is described from the perspective of a computer system.

In the process 400, the computer system can receive user input in a chatbot presented in a GUI at a user device (block 402). The chatbot can present user selectable buttons or other options, which can indicate various questions that the user can ask with respect to a particular retail environment, district, product, etc. The chatbot can include a text input field in which the user can input freeform text, which can include various questions, prompts, and/or queries. Refer to FIGS. 1 and 2 for further discussion.

The computer system can retrieve data associated with the user input from a plurality of data sources in block 404. Refer to at least blocks 304-310 in the process 300 of FIGS. 3A and 3B for further discussion.

In block 406, the computer system can apply one or more AI models to the user input and the retrieved data. For example, the computer system can segregate the data, as described in reference to blocks 312-318 of the process 300 in FIGS. 3A and 3B. The computer system can also determine customer sentiment based on processing the segregated data, as described in reference to blocks 320-326 of the process 300 of FIGS. 3A and 3B.

The computer system can also generate, based on the applying, a summarization of the retrieved data (block 408). In other words, the computer system can apply AI in parallel or in series to segregating the data and determining the customer sentiment in order to create generalizations or summaries of the data that is being ingested, the segregating that is being performed, and/or the customer sentiment determinations. The AI can be trained to generate a summarization that is easily understandable by the user and reproducible for output at a user device (e.g., in the chatbot). The summarization techniques are also advantageous because they provide for distilling complex and mass amounts of data having different data types into a user-friendly manner in little time (less than 2 minutes). Such techniques can more efficiently use available compute resources and be performed in such a way that is not possible in the human mind.

The computer system can generate actionable insights based on the summarization of the retrieved data in block 410. Refer to blocks 328-336 of the process 300 of FIGS. 3A and 3B for further discussion.

In block 412, the computer system can generate output based on the summarization and the actionable insights. Refer to blocks 338-346 of the process 300 of FIGS. 3A and 3B for further discussion.

The computer system can then return the output for presentation in GUIs at the user device in block 414. For example, the computer system can present the output in the chatbot as a response to the user input (block 416). As another example, the computer system can present the output in one or more visualization dashboards at the user device (block 418). Refer to FIGS. 6A, 6B, 6C, and 6D for further discussion.

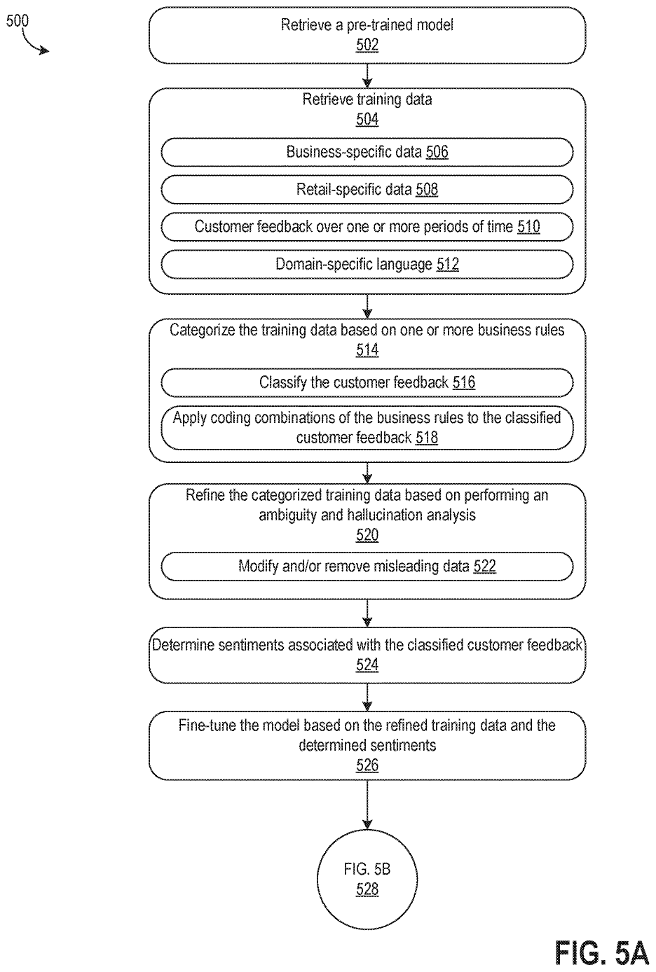

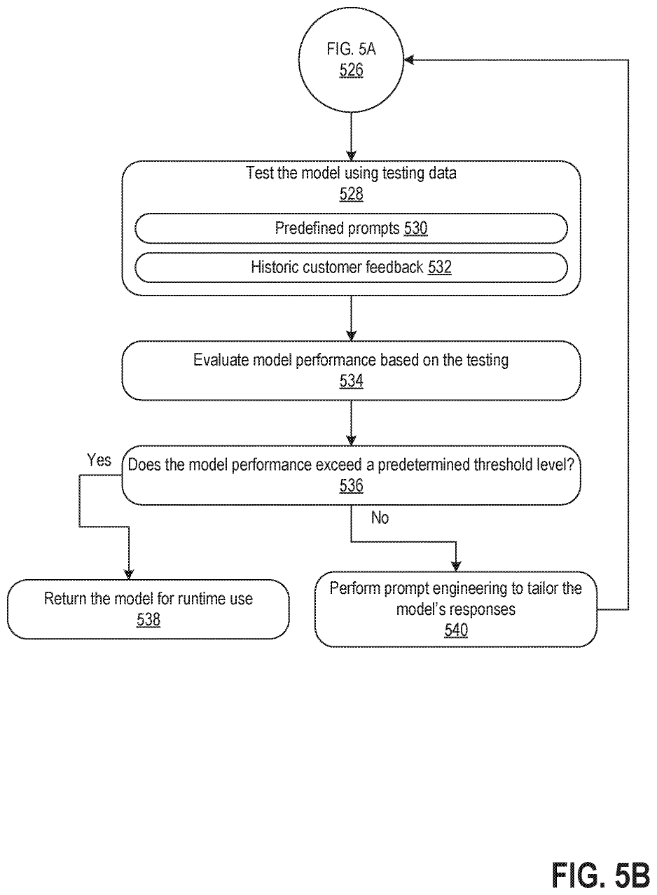

FIGS. 5A and 5B are a flowchart of a process 500 for training a model to generate summarizations and actionable insights based on user prompts in a chatbot. The process 500 can be performed iteratively and/or at predetermined times to allow for iterative learning and training of the AI described herein. The iterative learning can improve the AI's ability to accurately and more efficiently generate relevant information and responses based on the user prompts.

The process 500 can be performed by components of the computer system 102 that are described in reference to at least FIGS. 1 and 2. The process 500 can also be performed by one or more other software modules, applications, and/or engines that are programmed to perform the disclosed techniques. Such software modules, applications, and/or engines can be implemented by one or more computing systems, devices, computers, networks, cloud-based systems, and/or cloud-based services. For illustrative purposes, the process 500 is described from the perspective of a computer system.

Referring to the process 500 in both FIGS. 5A and 5B, the computer system can retrieve a pre-trained model in block 502. The pre-trained model can include but is not limited to a large language model (LLM), a GenAI model, a NLP model, and/or other types of language models.

In block 504, the computer system can retrieve training data. The training data can be retrieved from one or more data systems or external systems, as described in reference to at least FIG. 1. The training data can include but is not limited to business-specific data (block 506), retail-specific data (block 508), customer feedback over one or more periods of time (block 510), domain-specific language (block 512), and/or any combination thereof. The training data can be retrieved for a predetermined period of time (e.g., last day, last 3 months, last 6 months, last year).

The computer system can then categorize the training data based on one or more of the business rules (block 514). As described herein, the business rules can define coding combinations, which can map different types of products, information, customer feedback, etc. to different categories of customer feedback. Therefore, the computer system may classify the customer feedback in block 516. Additionally or alternatively, the computer system may apply coding combinations of the business rules to the classified customer feedback in block 518. The operations in blocks 514-518 can be performed using one or more AI models. Refer to at least block 318 in the process 300 of FIGS. 3A and 3B for further discussion about how the computer system can categorize the training data.

In block 520, the computer system can refine the categorized training data based on performing an ambiguity and hallucination analysis. For example, the computer system can modify and/or remove misleading data based on the analysis (block 522).

In the ambiguity analysis, the computer system can assess how well the trained model handles lexical ambiguity (e.g., words having multiple meanings) and/or syntactic ambiguity (e.g., phrases that can be parsed in different ways) to determine whether the model produces clear and contextually appropriate responses. Ambiguity may arise if customer feedback, for example, indicates that a sales associate helped them well but the sales associate gave them a low-quality product. In the feedback, the customer compliments the sales associate but has negative or neutral sentiment about the product. The model may face difficulty in parsing the sentiment in the feedback. The computer system can perform context-based filtering techniques to check whether the model is choosing a correct meaning based on a full phrase or query context. The computer system may use syntactic and/or semantic parses to check how the model resolves ambiguities in sentence structure as well. Sometimes, ambiguities can be manually annotated or labeled by relevant users, then model output can be reviewed against such annotations. In yet some implementations, ambiguity datasets can be generated and used to test the model's ability to handle such cases correctly. The computer system can establish a training metric that scores model performance in providing contextually appropriate responses. The training metric can be checked against predetermined threshold levels and/or benchmarks and used to determine whether training aspects, prompts, parameters, and/or datasets should be adjusted to fine-tune the model.

In the hallucination analysis, the computer system can assess how frequently and in what context the model may generate hallucinated content (e.g., factually incorrect statements, invented details) and how well it can be mitigated. The computer system can implement an automated fact-checking system, which can compare the model's output against reliable data sources to verify that the output is true. Sometimes, human evaluators may become involved to check the model output for its truthfulness. Factual consistency metrics can be used to compare generated output/text to a predetermined standard. Discrepancies or fabricated content can then be flagged as hallucinations (and modified and/or removed from the dataset, for example). Sometimes, precision and recall metrics can be used by the computer system to detect hallucinations when the precision or recall of factual information is low (or less than a predetermined threshold level). In yet some implementations, to detect hallucinations, the computer system can run multiple iterations of the same query through the model to check for consistency in responses. If the model generates difference answers for the same query, then the computer system can flag a hallucination and take appropriate action (e.g., refine prompts, data, and/or retrain or fine-tune the model). For example, to mitigate hallucinations during training, the computer system can augment the training data with additional, verified data so that the model can learn to distinguish between plausible-sounding content and actual facts. In yet some implementations, the computer system can expose the model to adversarial inputs that specifically try to confuse the model into generating hallucinations. This process can help the model learn to recognize and avoid generating false information.

Based on the abovementioned analyses, the computer system can determine which data to modify and/or remove such that the model, as trained, provides non-ambiguous and accurate responses. As indicated above, this can include augmenting the training data with verifiable and/or accurate data. This can include removing data from the training data that may appear plausible but not factual or accurate. This can additionally or alternatively include removing words that may have multiple meanings and/or phrases that can be interpreted in numerous different ways. Modifying the data in block 522 can include making refined training data.

The computer system may then determine sentiments (e.g., positive, negative, neutral) associated with the classified customer feedback in block 524. Sometimes, the sentiments in the feedback can be manually annotated or labeled by a user. Sometimes, the computer system can apply AI or other techniques described herein to automatically identify the sentiment of the classified feedback (e.g., using NLP, semantic analysis).

In block 526, the computer system can fine-tune the model based on the refined training data and the determined sentiments. Sometimes, the computer system can fine-tune the model with a smaller learning rate so that it does not overwrite knowledge already learned. During this training, the model can adjust its weights to improve its ability to predict sentiment. A loss function can also be used for classification tasks (e.g., cross-entropy loss) to optimize the model for accurate sentiment analysis and predictions.

Accordingly, the computer system may test the model using testing data (block 528). The testing data can derived as a portion of the retrieved data, the training data, and/or the refined data. Sometimes, the testing data can include additional data that is retrieved by the computer system. For example, the computer system can test the model with predefined prompts (block 530) and/or historic customer feedback (block 532). The predefined prompts can be automatically generated by the computer system and/or provided by human users. The prompts can cover a variety of sentiment scenarios that the model may be exposed to during runtime. The historic customer feedback can span over one or more predetermined periods of time and can include but are not limited to reviews, survey responses, social media comments, etc. The customer feedback can also span various sentiments and contexts that the model may be exposed to during runtime. As part of testing, the computer system can feed the predefined prompts and/or feedback into the model to ensure that the model processes these inputs and accurately outputs sentiment predictions, summarizations, and other information described herein for each input.

Next, the computer system can evaluate the model performance based on the testing (block 534). Evaluating the model performance can include comparing the model's predicted sentiment and outputs (e.g., actionable insights, summaries) with actual sentiment labels and expected outputs for each input. The computer system can generate accuracy metrics, such as accuracy, precision, recall, and/or F1 score to assess how well the model predicts sentiment and generates relevant information based on the input.

The computer system can determine whether the model performance exceeds a predetermined threshold level in block 536. An illustrative threshold level can be 90% accuracy. The threshold level can be adjusted based on a particular use case and/or implementation. The threshold level can therefore be greater than or less than 90% accuracy. As another illustrative example, the threshold level can be within a range of 90% through 100% accuracy.

If the model performance meets or exceeds the predetermined threshold level, the computer system can return the model for runtime use in block 538. As described above, sometimes the model can be iteratively trained and/or at predetermined times to ensure that the model continues to product accurate and reliable results. For example, the model can be iteratively trained in a feedback loop whenever a user interacts with the chatbot and/or provides user input in the dashboards described herein.

If the model performance does not meet or exceed the predetermined threshold level, the computer system can perform prompt engineering to tailor the model's responses in block 540. Prompt engineering can include designing and modifying the prompts to give to the model to guide it towards more relevant and desired outputs. Refining the prompts can include starting with direct prompts that ask the model to determine the sentiment and/or output based on an input. The computer system can also engineer the prompts into contextual prompts, which can include adding context around the input text to guide the model in understanding nuances in the input text. As another example, the computer system can engineer the prompts into task-specific prompts that may align with specific use cases. If the model struggles with ambiguous feedback, the computer system can modify the prompts to ask more specific questions. The prompts may also be engineered to include particular sentiment labels that the model is expected to output (e.g., positive, negative, neutral).

The computer system can then return to block 526, fine-tune the model based on the prompt engineering, and continue through the process 500 until the desired model performance is achieved. Fine-tuning the model can include feeding the model the engineered prompts with different phrasing and/or structures. Fine-tuning can also include incorporating a feedback loop, such that if the model is struggling with certain types of inputs (e.g., mixed sentiment, sarcastic revies, the prompts can be adjusted accordingly and iteratively to make the task clearer to the model. The fine-tuning can also include providing examples of sentiment and/or outputs within the prompt to guide the model.

FIGS. 6A, 6B, 6C, and 6D illustrate example graphical user interfaces (GUIs) that can be presented at a user device. As described above, the GUIs presented herein provide technical solutions and advantages in synthesizing large amounts of complex data that is highly processed using at least AI into easy-to-understand, user-friendly visualizations.

FIG. 6A illustrates a GUI 600 for presenting a dashboard of insights. The GUI 600 can include portions 602, 604, 606, 608, and/or any combination thereof. The GUI 600 can include additional, other, or fewer portions, in some implementations. The portions can be any other type of module, panel, and/or component of a GUI. The GUI 600 can also present key takeaways in a top portion of the GUI 600 to bring in the user's attention. The key takeaways can indicate, for example, top positive customer feedback and/or top negative customer feedback. In some implementations, the computer system 102 can, as part of summarizing the customer feedback described above, determine rankings of themes of customer feedback, sentiments, and/or other aspects of the feedback. The computer system 102 can then provide the ranked feedback and/or insights to the user device for presentation in the GUI 600. Sometimes, the computer system 102 can transmit a portion of the ranked feedback and/or insights to the user device for presentation, for example a top ranked feedback and/or one or more top ranked feedback in one or more different categories.

The portion 602 can include selectable options for filtering what information is presented in the GUI 600. For example, a user can select, amongst drop down menus, sources of customer feedback, channels, types of sentiment, divisions, districts, stores, banners, and/or dates. Channel can refer to a line of business or pillar within a retail organization provided by an entity, where customers can submit feedback specific to this pillar. A banner, on the other hand, can identify affiliated stores and/or sister companies. User selections in the GUI 600 can cause the GUI 600 to be automatically updated, at the user device, to present relevant information based on the user selections.

The portion 604 can present a table of top ranked issues that the computer system 102 identified using the disclosed techniques to process relevant customer feedback. The information presented in the portion 604 can be sortable based on user input and/or based on features such as issue, current count, prior count, difference, percentage change, and/or any combination thereof. Any of the issues presented in the portion 604 can also be user-selectable, which can cause a popout window with additional information about the selected issue to be presented as overlaying a portion of the GUI 600. In some implementations, the user selection of an issue can cause a new GUI to be presented at the user device.

The portion 606 can present visual and/or graphical elements that are relevant to the analysis performed by the computer system 102 in assessing the customer feedback. For example, the portion 606 can present visual elements that indicate information such as total number/quantity of feedback, a quantity of positive feedback, a quantity of negative feedback, a quantity of neutral feedback, and/or any combination thereof. The visual elements can include one or more different indicia to display whether such metrics are trending upwards and/or downwards. Sometimes, the visual elements can include indicators of prior relevant quantities (e.g., quantities that were determined a last time that the user requested information using the selectable options in the portion 602). The graphical elements can include a graph indicating trends in customer feedback metrics, such as NPS. The graph can depict such trends over one or more periods of time (e.g., last 6 months).

The portion 608 can present pie charts or other graphical elements that illustrate various aspects of the customer feedback that is analyzed by the computer system 102 and presented in the GUI 600. For example, the portion 608 can present circle elements for star rating overview, star rating distribution, channel distribution, sentiment distribution, and/or any combination thereof. Fewer, different, or additional aspects of the analyzed customer feedback that is described herein can also be presented as graphical elements in the portion 608.

FIG. 6B illustrates the GUI 600 with a pop-out window 610 overlaying a portion of the GUI 600. The window 610 can be presented in response to the user selecting one or more visual or graphical elements that are depicted and described in the GUI 600 with respect to FIG. 6A. Here, the window 610 can present customer feedback that was specific to the user-selected visual or graphical element(s). The window 610 can present additional information about the customer feedback, such as summaries that are generated by the computer system 102 using the disclosed techniques, identification of a channel by which the customer feedback was received, any links or associations to surveys associated with the customer feedback, sentiment analysis/identification, etc. Similar pop-out windows can be presented in the GUI 600 in response to user selection of other portions of the GUI 600 described further below.

FIG. 6C illustrates the GUI 600 with additional portions 620, 621, 622, and/or 624. The portions 620, 622, and/or 624 can be presented in the GUI 600 as the user scrolls down in the GUI 600 shown and described in FIG. 6A.

The portion 620 can be configured to present visual elements corresponding to topic and/or item distribution. For example, the portion 620 can present a bubble chart that visually represents shopper feedback issues, enabling simultaneous comparison of multiple dimensions.

The portion 621 can be configured to present a graph that provides a view of issues and volumes of the issues. Sometimes, the portion 621 can present a graph that provides a view of a particular issue and a volume of that issue.

The portion 622 can be configured to present a graphical element (e.g., a graph) corresponding to an average star rating change between a predetermined period of time (e.g., February 2025 and March 2025 in the illustrative example). The predetermined period of time can be defined by the user using the selectable options in the portion 602 described in reference to FIG. 6A.

The portion 624 can be configured to present a word cloud of topics that appeared in the analyzed customer feedback.

A chatbot 630 is also presented as overlaying a portion of the GUI 600. In some implementations, the chatbot 630 can be displayed as a panel on a side (e.g., top, bottom, left, right) of the GUI 600 having the portions described herein. The chatbot 630 can include an input field 632. The user can input their questions, queries, and/or prompts into the input field 632. Once the user submits their input in the input field 632 (e.g., pressing ENTER on a keyboard, selecting a button to submit the input), the user input can be transmitted to the computer system 102 to perform the processing techniques described herein. Output from performing the processing techniques can then be transmitted back to the user device and presented in the chatbot 630, as shown and described in reference to FIG. 6D.

Sometimes, the chatbot 630 can also present one or more selectable options 634A-N. The selectable options 634A-N can pertain to various types of questions that the user can ask the chatbot 630. User selection of one of the options 634A-N can be transmitted back to the computer system 102 for further processing.

FIG. 6D illustrates the GUI 600 with the chatbot 630 updated to present a response to user input. In this example, the user selected one of the options 634A-N described in FIG. 6C to generate more insights about a particular store (e.g., store number 11). The user input was transmitted to the computer system 102, which performed the disclosed techniques to generate a summary of insights about the particular store and recommendations/actionable insights. The computer system 102's generated information is presented in the chatbot 630 in FIG. 6D. As described herein, the disclosed technology provides technical solutions and advantages in accurately processing many disparate data points, data sources, and/or data types to generate curated summaries and insights in a matter of seconds to 1-2 minutes. These techniques more efficiently utilize available compute resources and encompasses operations that could not be performed in the human mind. The chatbot 630, as shown in FIG. 6D, can provide the user with curated, aggregated information for a specific store, district, product, and/or any other type of classifier/categorization the user chooses. The dashboard in the GUI 600, on the other hand, can provide summaries and overviews of more information, less specific to user-specified classifiers and/or categorizations.

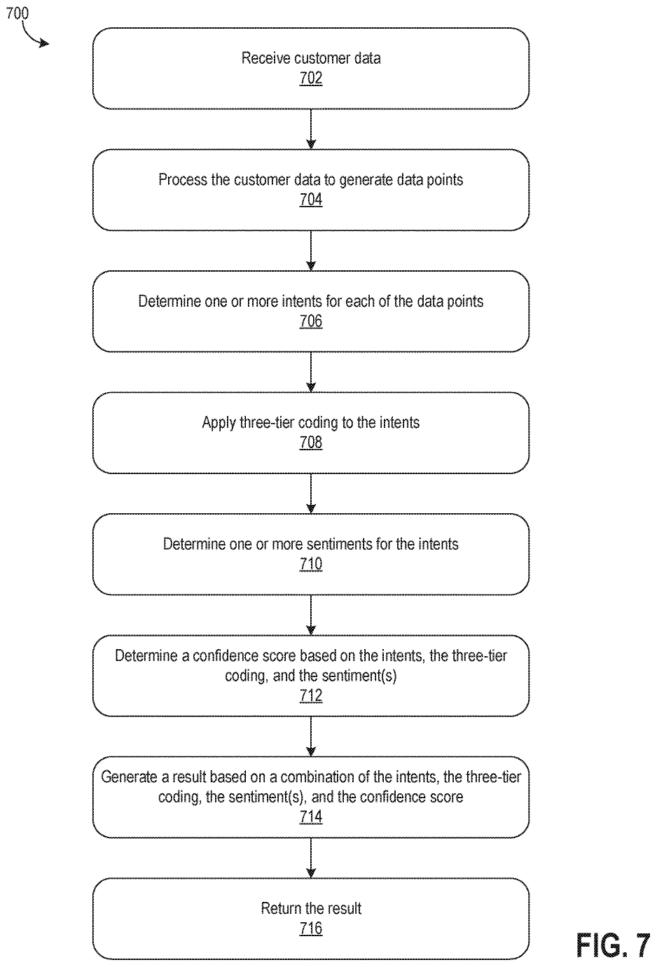

FIG. 7 is a flowchart of a process 700 for determining intents from customer feedback and generating associated results, such as actionable insights. The process 700 can be performed as part of performing one or more other processes described herein. For example, the process 700 can be performed as part of determining customer sentiment in blocks 320-326 of the process 300 of FIGS. 3A and 3B.

The process 700 can be performed by components of the computer system 102 that are described in reference to at least FIGS. 1 and 2. The process 700 can also be performed by one or more other software modules, applications, and/or engines that are programmed to perform the disclosed techniques. Such software modules, applications, and/or engines can be implemented by one or more computing systems, devices, computers, networks, cloud-based systems, and/or cloud-based services. For illustrative purposes, the process 700 is described from the perspective of a computer system.

In the process 700, the computer system can receive customer data in block 702. The customer data can include any customer feedback described herein. For example, the customer data can include but is not limited to product reviews, website feedback, delivery comments, application reviews, customer comments and reviews, self-checkout feedback, health platform reviews, social media reviews, and/or any combination thereof.

In block 704, the computer system can process the customer data to generate data points. Processing the data can include denoting the customer data as D and the number of data points as n:

D={d1,d2, . . . ,dn}

The computer system can determine one or more intents for each of the data points in block 706. For example, the computer system can convert each data point into multiple intents with a function as f.

Iᵢⱼ=f(dᵢ)for i=1,2 . . . ,n and j=1,2, . . . ,mᵢ

Where each data point is dᵢ, the multiple intents are Iᵢⱼ, and the number of intents in a data point are dᵢ.

The computer system can also apply three-tier coding to the intents (block 708). This function can be denotated as g:

I_{Tij}=g(Iᵢⱼ) for i=1, 2, . . . , n and j=1,2, . . . , mᵢ

Where g is the function that applies three-tier coding to each intent Iᵢⱼ, resulting in I_{Tij}.

The computer system can determine one or more sentiments for the intents in block 710. The computer system can determine the sentiment s for each of the intents with a function as h:

Sᵢⱼ=k(Iᵢⱼ,I_{Tij},Sᵢⱼ)for i=1,2, . . . ,n and j=1,2, . . . , mᵢ
Where k is the function that identifies the sentiment for each intent with three-tier coding I_{Tij}.

Accordingly, the computer system can determine a confidence score based on the intents, the three-tier coding, and/or the sentiment(s) in block 712. The computer system can identify the confidence score C as:

Cᵢⱼ=k(Iᵢⱼ,I_{Tij},Sᵢⱼ)for i=1,2, . . . ,n and j=1,2, . . . ,mᵢ

Where k is the function that calculates the confidence score from the intent Iᵢⱼ, three-tier coding sentiment Sᵢⱼ.

The computer system can generate a result based on a combination of the intents, the three-tier coding, the sentiment(s), and/or the confidence score (block 714) as:

Rᵢⱼ=(Iᵢⱼ,I_{Tij},Sᵢⱼ,Cᵢⱼ)for i=1,2, . . . , and j=1,2, . . . ,mᵢ

Where Rᵢⱼ is the result containing a combination of the intents, three-tier coding, sentiment, and/or confidence score for each intent in each data point.

Accordingly, the overall process 700 can be summarized as:

Rᵢⱼ=(f(dᵢ),g(dᵢ),h(g(f(dᵢ))),k(f(dᵢ),g(f(dᵢ),h(g(f(dᵢ))))) for i=1,2, . . . ,n and j=1,2, . . . mᵢ

Then, the computer system can return the result (block 716). Returning the result can include processing the result to generate actionable insights that can be easily understood and digestible by a relevant user. As described herein, the disclosed techniques provide technical advantages in processing many complex disparate types of data and/or sources of data, generating results based on the processing, and then converting or otherwise distilling the results into GUI elements for presentation to and interaction with a human user.

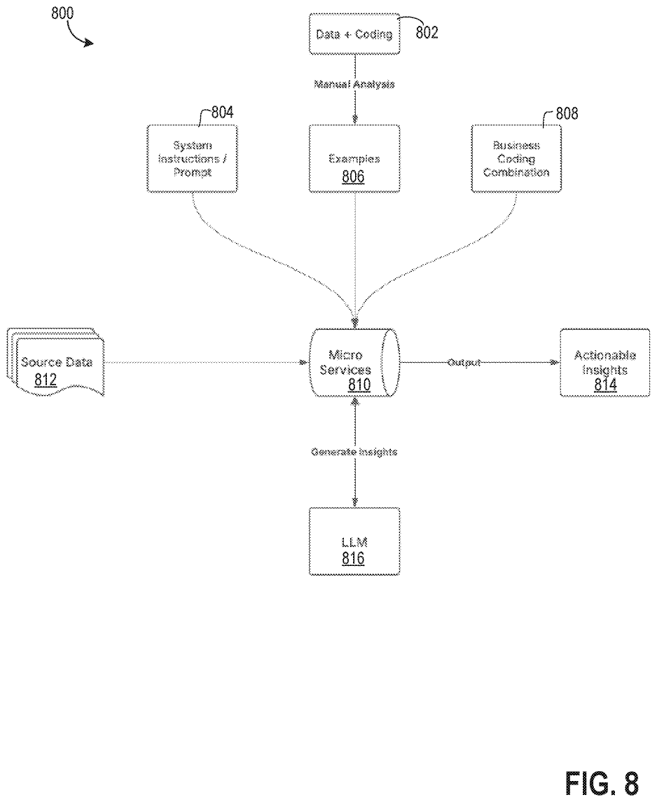

FIG. 8 is a diagram of a dataflow 800 to generate actionable insights described herein. The dataflow 800 can be implemented by components of the computer system 102 that are described in reference to at least FIGS. 1 and 2. The dataflow 800 can also be performed by one or more other software modules, applications, and/or engines that are programmed to perform the disclosed techniques. Such software modules, applications, and/or engines can be implemented by one or more computing systems, devices, computers, networks, cloud-based systems, and/or cloud-based services. For illustrative purposes, the dataflow 800 is described from the perspective of a computer system.

In the dataflow 800, data and coding 802 can be provided as inputs to the computer system. The data and coding 802 can include human examples using historical data and/or coding methodologies. The coding can systematically link feedback intents to their corresponding business and/or product lines across various platforms. The data and coding can be processed and analyzed to generate examples 806. In some implementations, human-driven output can be combined with coding, generated based on historical data and input into the computer system described herein. A Retrieval-Augmented Generation (RAG) concept can be used for processing and analyzing the data to generate the examples 806. This framework can enhance the computer system's understanding of the data and produce more accurate outputs.

One or more microservices 810 can be configured to ingest data such as the examples 806, system instructions/prompt 804, and/or business coding combination(s) 808. The system instructions can include guidelines for the computer system that define and ensure consistent, accurate, and safe behavior. These guidelines may encompass rules for data processing, user interaction, security protocols, etc. The coding combination can systematically link feedback intents to their corresponding business and/or product lines.

The microservice(s) 810 can be configured to process the ingested data in order to generate output, such as actionable insights 814. To generate the actionable insights 814, the microservice(s) 810 can obtain source data 812 and provide the system instructions/prompt 804, the examples 806, the business coding combination(s) 808, the source data 812, and/or any combination thereof as input to a model, such as LLM 816. The source data can include unprocessed customer feedback from various platforms, in contrast to other data that may be derived from human-driven manual analysis of historical records. The LLM 816 can be any of the models and/or AI described herein. The LLM 816 can generate output, such as the actionable insights 814, which the microservice(s) 810 then provides to an end user computing device. In some implementations, the LLM 816 can generate information that can be further processed by the microservice(s) 810 to generate the actionable insights 814.

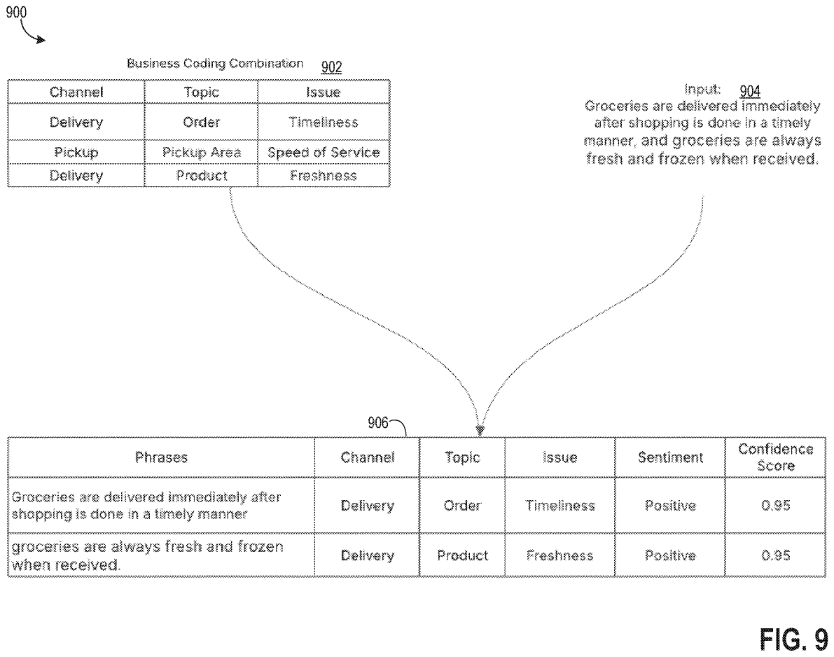

FIG. 9 is an illustrative example 900 of using the disclosed techniques of FIG. 7 to determine intents from customer feedback. To determine intent from the customer feedback, a computer system (e.g., the computer system 102) can obtain data such as business coding combinations 902 and input 904.

The business coding combinations 902 can include a matrix or other data form in which various aspects of a business/retail environment are mapped or otherwise correlated with each other. For example, the business coding combinations 902 can be categorized into channel, topic, and issue. Example channels can include delivery and/or pickup. One or more other channels may also be defined for a particular industry and/or retail environment. Example topics can include order, pickup area, and/or product. One or more other topics can also be defined for the industry and/or retail environment. Example issues can include timeliness, speed of service, and/or freshness. One or more other types of issues may be defined in the business coding combinations 902. The channels, topics, and issues described herein can be correlated, associated, and/or otherwise mapped with each other, as shown in the example 900 of FIG. 9. For example, a delivery channel can be associated with an order having a timeliness issue. As another example, a pickup channel can be associated with a pickup area having a speed of service issue. As yet another example, a delivery channel can be associated with a product having a freshness issue. The issues that are identified in the business coding combination 902 can be positive, neutral, and/or negative issues, which can be used to accurately determine intent (and subsequently sentiment) from any customer feedback. The business coding combinations 902 can include additional, fewer, or different combinations of channels, topics, and issues.

The input 904 can include customer feedback that has been collected as described herein. The input 904 can include other comments or data about a customer experience and/or operations in a particular industry and/or retail environment. As an illustrative example, the input 904 indicates that groceries are delivered immediately after shopping is done in a timely manner and that the groceries are always fresh and frozen when received.

The computer system can process the business coding combinations 902 and the input 904 using the AI, NLP, semantic, and textual analysis techniques described herein to generate results 906. Refer to FIG. 7 for further discussion about the techniques performed to generate the results 906.

As shown in the results and the illustrative example of the input 904, the computer system identified two distinct phrases in the input 904: the first being that the groceries are delivered immediately after shopping is done in a timely manner and the second being that the groceries are always fresh and frozen when received. Refer to block 704 in the process 700 of FIG. 7 for further discussion. By identifying the two distinct phrases, the computer system can classify each phrase according to the business coding combinations 904. Once each phrase is classified, the computer system can apply the AI to determine a sentiment for the phrase. The computer system can also apply the AI to determine a confidence score corresponding to intent or the sentiment determination for each phrase. Refer to blocks 706, 708, 710, and 712 in the process 700 of FIG. 7 for further discussion.

Here, the computer system classified the first phrase as being associated with the delivery channel, the topic of an order, and the issue of timeliness. The computer system then determined, based on applying the AI, that the first phrase has a generally positive sentiment. The computer system's confidence in this sentiment determination (or intent) is 0.95, which can correspond to 95% certain that the first phrase has a positive sentiment.

Similarly, the computer system classified the second phrase as being associated with the delivery channel, the topic of a product, and the issue of freshness. The computer system then determined, based on applying the AI, that the second phrase has a generally positive sentiment. The computer system's confidence in this sentiment determination (or intent) is also 0.95, which can correspond to 95% certain that the second phrase has a positive sentiment.

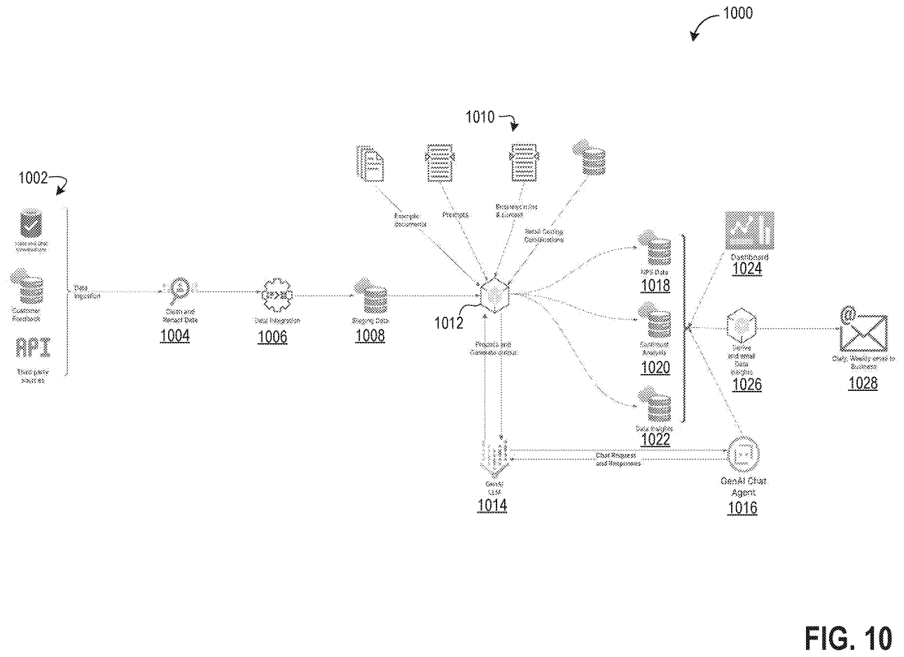

FIG. 10 is an example system architecture 1000 that can be used to perform the disclosed techniques. One or more components in the architecture 1000 can be part of the computer system 102 described herein. In the architecture 1000, data can be ingested from data sources 1002. The data ingested from the data sources 1002 can include but are not limited to voice and/or chat conversations, customer feedback, and/or other third party data described herein.

Once the data is ingested in the system architecture 1000, the computer system can clean and redact the data (block 1004). The computer system can also integrate the data (block 1006) with each other and with other data and/or systems of the architecture 1000. The integrated data can be stored, such as in a staging datastore (block 1008), where the data can be maintained until it is used for downstream processes/operations, such as determining sentiment in customer feedback and/or generating actionable insights.

One or more processing services/modules (e.g., the microservice(s) 810 in FIG. 8, other components of the computer system 102) of the architecture 1000 can be configured to retrieve data from the staging datastore and other data sources to perform the downstream processes/operations in block 1012. For example, the processing services/modules can be configured to receive the data from the staging datastore and external data 1010 (e.g., example documents, prompts, business rules and context, retail coding combinations) and provide that data as input to an LLM or other AI and/or models in block 1014 (e.g., the LLM 816 in FIG. 8). The LLM can process the received data to generate output or other results. In some implementations, the generated output can include the actionable insights described herein. The LLM can return the output as a response to a chat request from a chat agent of a chatbot 1016. The chatbot 1016, as described herein, can be presented at a user device of a relevant user.

The output can include summarizations of customer feedback and/or a customer feedback landscape for a particular industry and/or retail environment. As another example, the generated output can include indications of sentiment/intent for the customer feedback, which can be further processed by the processing services/modules in block 1012. The processing services/modules can be configured to store the results/output from the LLM in one or more datastores, such as a NPS datastore 1018, a sentiment analysis datastore 1020, and/or a data insights datastore 1022. Any of the data that is stored can be later retrieved by the processing services/modules of the computer system to generate additional information, insights, and/or dashboards for presentation to relevant users. For example, the processing services/modules of the computer system can be configured to generate a dashboard 1024 using the data maintained in the datastores 1018-1022 for presentation at a user device. The processing services/modules of the computer system can generate emails, push notifications, and other alerts with the actionable insights and other relevant information (block 1026). Said emails, push notifications, and other alerts can be transmitted to relevant users as daily, weekly, or other emails (block 1028). Chat requests from a user interacting with the chatbot 1016 may also be stored in the datastores 1018-1022 for later use in the disclosed technology. Responses to the chat requests that are generated by the LLM 1014 and presented in the chatbot 1016 may also be stored in the datastores 1018-1022 and/or generated based at least in part on the data that is stored in the datastores 1018-1022.

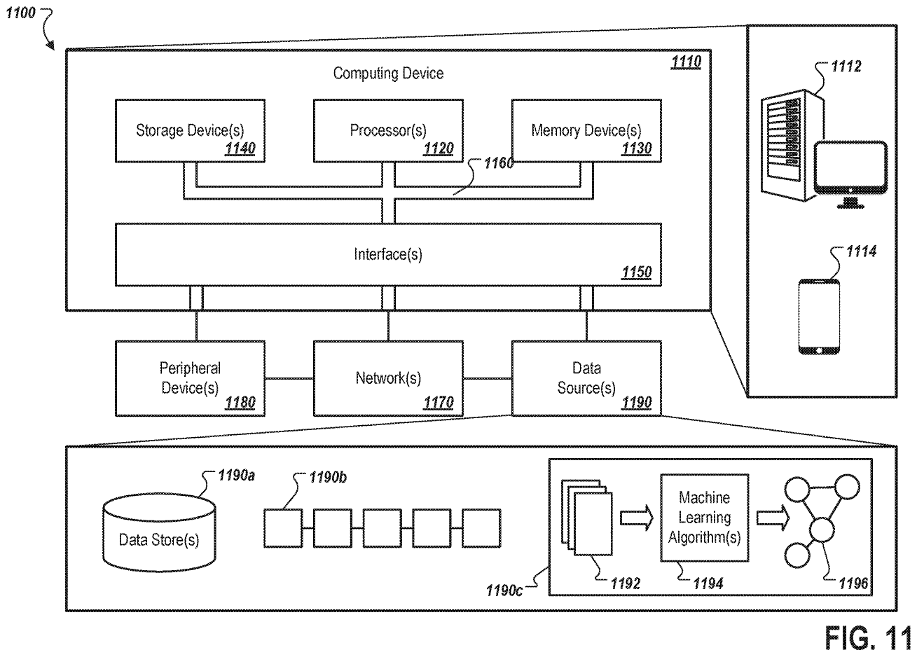

FIG. 11 is a schematic diagram that shows an example of a computing system 1100 that can be used to implement the techniques described herein. The computing system 1100 includes one or more computing devices (e.g., computing device 1110), which can be in wired and/or wireless communication with various peripheral device(s) 1180, data source(s) 1190, and/or other computing devices (e.g., over network(s) 1170). The computing device 1110 can represent various forms of stationary computers 1112 (e.g., workstations, kiosks, servers, mainframes, edge computing devices, quantum computers, etc.) and mobile computers 1114 (e.g., laptops, tablets, mobile phones, personal digital assistants, wearable devices, etc.). In some implementations, the computing device 1110 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 1110, and an entire system can be made up of multiple devices communicating with each other. For example, the computing device 1110 can be part of a computing system that includes a network of computing devices, such as a cloud-based computing system, a computing system in an internal network, or a computing system in another sort of shared network. Processors of the computing device (1110) and other computing devices of a computing system can be optimized for different types of operations, secure computing tasks, etc. The components shown herein, and their functions, are meant to be examples, and are not meant to limit implementations of the technology described and/or claimed in this document.

The computing device 1110 includes processor(s) 1120, memory device(s) 1130, storage device(s) 1140, and interface(s) 1150. Each of the processor(s) 1120, the memory device(s) 1130, the storage device(s) 1140, and the interface(s) 1150 are interconnected using a system bus 1160. The processor(s) 1120 are capable of processing instructions for execution within the computing device 1110, and can include one or more single-threaded and/or multi-threaded processors. The processor(s) 1120 are capable of processing instructions stored in the memory device(s) 1130 and/or on the storage device(s) 1140. The memory device(s) 1130 can store data within the computing device 1110, and can include one or more computer-readable media, volatile memory units, and/or non-volatile memory units. The storage device(s) 1140 can provide mass storage for the computing device 1110, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1150 can include various communications interfaces (e.g., USB, Near-Field Communication (NFC), Bluetooth, WiFi, Ethernet, wireless Ethernet, etc.) that can be coupled to the network(s) 1170, peripheral device(s) 1180, and/or data source(s) 1190 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 1150 can include a control interface that receives commands from an input device (e.g., operated by a user) and converts the commands for submission to the processors 1120. The interface(s) 1150 can include a display interface that includes circuitry for driving a display to present visual information to a user. The interface(s) 1150 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 1170 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1110 can communicate with the peripheral device(s) 1180, the data source(s) 1190, and/or other computing devices over the network(s) 1170. In some implementations, the computing device 1110 can directly communicate with the peripheral device(s) 1180, the data source(s), and/or other computing devices.

The peripheral device(s) 1180 can provide input/output operations for the computing device 1110. Input devices (e.g., keyboards, pointing devices, touchscreens, microphones, cameras, scanners, sensors, etc.) can provide input to the computing device 1110 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1110 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1190 can provide data for use by the computing device 1110, and/or can maintain data that has been generated by the computing device 1110 and/or other devices (e.g., data collected from sensor devices, data aggregated from various different data repositories, etc.). In some implementations, one or more data sources can be hosted by the computing device 1110 (e.g., using the storage device(s) 1140). In some implementations, one or more data sources can be hosted by a different computing device. Data can be provided by the data source(s) 1190 in response to a request for data from the computing device 1110 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1190a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 1190b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 1190c. The machine learning system(s) 1190c, for example, can be used to analyze data from various sources (e.g., data provided by the computing device 1110, data from the data store(s) 1190a, data from the blockchain(s) 1190b, and/or data from other data sources), to identify patterns in the data, and to draw inferences from the data patterns. In general, training data 1192 can be provided to one or more machine learning algorithms 1194, and the machine learning algorithm(s) can generate a machine learning model 1196. Execution of the machine learning algorithm(s) can be performed by the computing device 1110, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal . . . he term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A system for determining actionable insights in a retail environment based on processing disparate data types, the system comprising:
processors; and
memory storing instructions that, when executed by the processors, cause the processors to perform operations comprising:
ingesting data associated with a retail environment, wherein the data comprises customer feedback of disparate data types;
processing the ingested data to determine customer sentiment associated with the customer feedback of disparate data types;
determining, based on the customer sentiment, actionable insights for the retail environment;
generating output based at least in part on the actionable insights; and
returning the output for presentation in a graphical user interface (GUI) display of a user device.

2. The system of claim 1, wherein the operations further comprise:
receiving, from the user device, user input in a chatbot presented at the user device, wherein the user input indicates a request for information about the retail environment;
identifying the data associated with the retail environment based on processing the user input; and
performing the ingesting, the processing, the determining, the generating, and the returning based on identifying the data associated with the retail environment.

3. The system of claim 1, wherein the operations further comprises:
generating, using AI, a summarization of at least one of the customer sentiment and the actionable insights for the retail environment; and
returning the summarization for presentation in the GUI display of the user device.

4. The system of claim 1, wherein:
the ingested data comprises business coding combinations, and
processing the ingested data to determine the customer sentiment associated with the customer feedback of disparate data types further comprises:
categorizing the customer feedback of disparate data types based on applying an AI model to the ingested data, wherein the AI model was trained to correlate the customer feedback of disparate data types with at least one of the business coding combinations to categorize the customer feedback of disparate data types.

5. The system of claim 4, wherein determining the customer sentiment further comprises applying the AI model to the categorized customer feedback of disparate data types, wherein the AI model was trained to determine the customer sentiment based on semantically analyzing the categorized customer feedback of disparate data types.

6. The system of claim 4, wherein the AI model was trained in a process comprising:
retrieving a pre-trained model;
retrieving training data;
categorizing the training data based on one or more business rules;
refining the categorized training data based on performing an ambiguity and hallucination analysis;
determining sentiments associated with the categorized training data; and
fine-tuning the pre-trained model based on the refined training data and the determined sentiments to generate the AI model.

7. The system of claim 6, wherein the pre-trained model comprises a large language model (LLM).

8. The system of claim 6, wherein the training data comprises business-specific data, retail-specific data, customer feedback over one or more periods of time, and domain-specific language data.

9. The system of claim 6, wherein categorizing the training data based on the one or more business rules comprises:
classifying the customer feedback; and
applying coding combinations of the one or more business rules to the classified customer feedback of disparate data types to generate the categorized training data.

10. The system of claim 1, wherein processing the ingested data to determine the customer sentiment associated with the customer feedback of disparate data types comprises:
processing the customer feedback of disparate data types to identify phrases in the customer feedback of disparate data types;
determining intents for the identified phrases;
applying three-tier coding to the intents;
determining sentiments for the intents;
determining a confidence score based on the intents, the three-tier coding, and the sentiments; and
determining the customer sentiment based on a combination of the intents, the three-tier coding, the sentiments, and the confidence score.

11. The system of claim 1, wherein determining, based on the customer sentiment, the actionable insights for the retail environment comprises identifying issues to address in the retail environment to improve the customer sentiment.

12. The system of claim 1, wherein determining, based on the customer sentiment, the actionable insights for the retail environment comprises identifying areas of improvement in the retail environment to improve the customer sentiment.

13. The system of claim 1, wherein determining, based on the customer sentiment, the actionable insights for the retail environment comprises generating recommendations for improving employee training in the retail environment.

14. The system of claim 1, wherein determining, based on the customer sentiment, the actionable insights for the retail environment comprises generating recommendations to improve resource allocation and strategy in the retail environment.

15. The system of claim 1, wherein generating the output based at least in part on the actionable insights comprises generating visualizations of the actionable insights and a summarization of the customer feedback of disparate data types in a dashboard for presentation in the GUI display of the user device.

16. The system of claim 1, wherein generating the output based at least in part on the actionable insights comprises generating reports of the actionable insights and a summarization of the customer feedback of disparate data types.

17. The system of claim 1, wherein generating the output based at least in part on the actionable insights comprises generating emails reporting the actionable insights and a summarization of the customer feedback of disparate data types.

18. The system of claim 1, wherein generating the output based at least in part on the actionable insights comprises generating personalized alerts about the actionable insights and a summarization of the customer feedback of disparate data types.

19. The system of claim 1, wherein the output is presented in a dashboard in the GUI display of the user device.

20. The system of claim 18, wherein the actionable insights are presented in a chatbot that is presented simultaneously with the dashboard in the GUI display of the user device, wherein the dashboard presents, as graphical elements, other information about the retail environment and the customer sentiment.
